(19) United States
(12) Patent Application Publication
(10) Pub. No.: US 2024/0164404 A1
(43) Pub. Date: May 23, 2024

(54) TEXTURED PROTEIN MATERIAL CONTAINING FUNGI, METHODS OF MAKING THE SAME, AND USES THEREOF

(71) Applicant: TERRAMINO INC., Berkeley, CA (US)

(72) Inventors: John FRELKA, Berkeley, CA (US); Kimberlie LE, Berkeley, CA (US); Joshua NIXON, Berkeley, CA (US)

(21) Appl. No.: 18/550,766

(22) PCT Filed: Mar. 16, 2022
(86) PCT No.: PCT/US2022/020575

§ 371 Date: Sep. 15, 2023

Related U.S. Application Data
(60) Provisional application No. 63/161,865, filed on Mar. 16, 2021.

(51) Int. Cl. A23J 3/20; A23J 3/22; A23J 3/26; A23L 31/00

(52) U.S. Cl. CPC A23J 3/20; A23J 3/227; A23J 3/26; A23L 31/00

(57) ABSTRACT

Methods of producing fungi-based textured protein food products are described, the methods generally including providing a fungi-based protein source, mixing the fungi-based protein source with other ingredients (including secondary protein sources) to form a blend, and extruding the blend. The method may include performing the extrusion using operating parameters that result in denaturing the secondary proteins while leaving fungal fibers of the fungi-based proteins intact. Fungi-based textured protein food products are also described, the fungi-based textured protein food products including intact fungal fibers aligned with networks of denatured non-fungal protein formed about and around the fungal fibers.

### CROSS-REFERENCE TO RELATED APPLICATIONS

The present application claims priority under 35 U.S.C. § 119(e) to U.S. Provisional Patent Application No. 63/161,865, filed Mar. 16, 2021, the entirety of which is hereby incorporated by reference.

### TECHNICAL FIELD

Described herein is a textured protein material containing fungi, methods of making textured protein material containing fungi, and uses of textured protein material containing fungi.

### BACKGROUND

Alternative meats, meat analogues and meat mimetics are generally defined ascombinations of flavors, fats, binders, and protein to mimic the texture, flavor, and nutrition of meat (which can include seafood). Much effort has gone into creating alternative meats that resemble meat in taste, texture and nutrition as closely as possible. However, to date, alternative meats generally fall short in at least one, if not several, of these categories.

One reason why alternative meats generally fail to sufficiently mimic natural meat is that alternative meats use plants as a major component of the alternative meat. Plant biomass has cellulose, is high in moisture, and has a rigidity that is not easily turned into something that resembles the texture of natural meat. As such, the protein from the plant must be extracted and then extruded to achieve a more “meat-like” texture at the macrostructure level. However, the microstructure of natural meat muscle fibers still cannot be sufficiently replicated with plant-based proteins.

Another problem that may be experienced with plant-based meat alternatives is that in addition to flavors typically added to meat alternatives in order to mimic meat, masking agents and/or special (and usually wasteful) plant processing techniques are typically required in order to avoid off-flavors or bitter notes that comes from the plants. This may increase the complexity of preparing plant-based meat alternatives.

Another issue often faced by currently known processes for producing alternative meats relates to cost and efficiency. While plant-based meats are generally much better than animal-based meats in terms of production costs and efficiency, the processing of plant-based proteins to make protein concentrates or protein isolates used in alternative meats typically results in a large amount of plant biomass that is wasted. This makes the process both more costly and less efficient.

Despite all of the above, textured vegetable protein (TVP) is a well-known and popular food product that has been around since at least the 1970s. The process of preparing TVP generally involves mixing defatted protein powders with water under pressure to create a thermoplastic mass that is then extruded through a die to create the proteinaceous TVP product. TVP is typically provided as a dry to semi-dry particulate that when rehydrated by steaming or boiling resembles meat in appearance and texture, and cantherefore be used to create meat-like products. The defatted protein powder used in the process of making TVP is often defatted soy flour, though other materials can also be used, such as wheat, peas, or other pulses.

However, TVP generally suffers from all of the above-described issues due to its reliance on, e.g., soy, wheat or other vegetables for its primary protein source. Accordingly, a need currently exists for TVP-like products that do not suffer from some or all of the issues discussed above.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a method of forming a fungi-based textured protein food product is described. The method can include the steps of providing a fungi-based protein source, the fungi-based protein source comprising a plurality of fungal fibers; a step of mixing the fungi-based protein source with at least one secondary protein source to form a blend; and a step of extruding the blend to form a fungi-based textured protein food product. Extruding the blend can be carried out in a manner such that the secondary protein is denatured and greater than 40% of the fungal fibers remain intact.

In some embodiments, a fungi-based textured protein food product is described. The fungi-based textured protein food product includes a fungi-based protein source comprising a plurality of intact fungal fibers, and a plurality of networks of denatured protein arranged around and about the plurality of intact fungal fibers.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a flow chart illustrating a method for producing a fungi-based textured protein food product in accordance with various embodiments described herein.

FIG. 2 is a flow chart illustrating a method for producing a fungi-based textured protein food product in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Described herein are various embodiments of a textured protein food product containing fungi as a protein source and methods of making the same. The use of fungi as a protein source in textured protein food products can be beneficial for several reasons. Phylogenetically speaking, fungi are more closely related to animals than plants, which means that when fungi is incorporated into a textured protein food product, the textured protein food product exhibits textural, taste, and nutritional benefits that are similar to meat. For example, the mycelium of filamentous fungi, at a structural level, is approximately the same size as animal muscle fibers which means that they have a texture that is similar to meat when arranged into a complexed matrix. Thus, a textured protein food product incorporating fungi are especially useful when used as a meat alternative or meat analogue. The combination of the microstructure of the fungi with larger textures formed via, e.g., HMEC (discussed in greater detail below) ultimately creates a meat-like texture on multiple size scales simultaneously.

Additionally, the profile of the textured protein food product including fungi as described herein can be non-allergenic, which is an advantage over traditional TVPs that include, e.g., wheat and/or soy, both of which are common allergens.

Textured protein food products including fungi as described herein can also have improved taste due to the fungi-based proteins being neutral in taste. Because fungi-based protein is neutral in taste, the textured protein food product does not need to be processed in a special way and/or include masking ingredients that aim to suppress the taste of the protein. Instead, it is relatively easy to provide the textured protein food product with whatever taste is desired by the simple addition of the desired flavoring. The fungi biomass that can be used is neutral tasting and enables the use of fewer ingredients to achieve a superior tasting product that tastes more similar to meat or seafood. In addition, the fungi biomass that can be used in various embodiments is slightly savory and umami which makes it a superior base protein source that is used for making a savory base protein that is viscerally enjoyable to the human palate.

Additionally, fungi-based textured protein food products described herein can use biomass from filamentous fungi, making the production process extremely efficient. The use of this specific type of fungi means that material that may otherwise be treated as waste or non-usable is instead turned into food that is extremely nutrient dense and high in protein. As such, there are positive environmental externalities that can be achieved as a result of the upcycling process, and the processes described herein may be much less intensive than, e.g., growing plants for the end use in a high protein product or meat/seafood alternative.

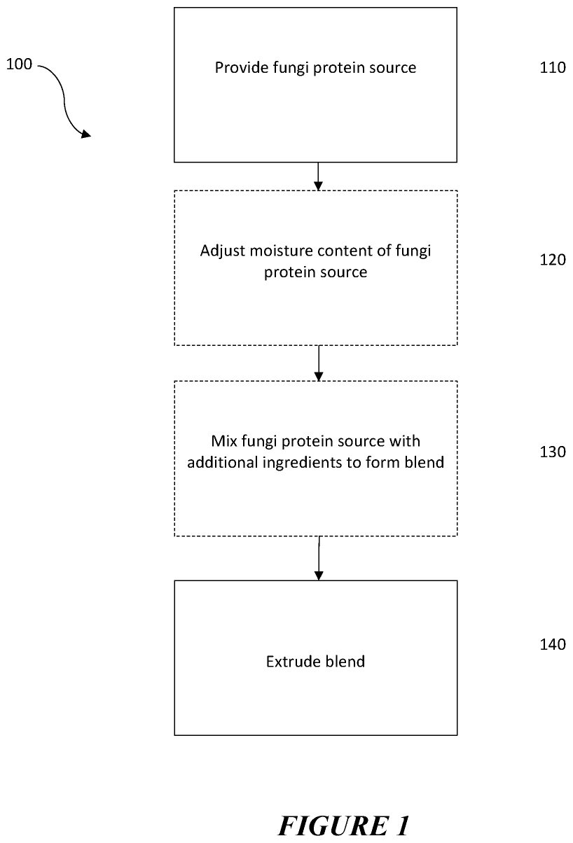

With respect to FIG. 1, a flow chart illustrating various embodiments of a method 100 for producing textured protein food products comprising fungi generally comprises a step 110 of providing a fungi protein source, an optional step 120 of adjusting the moisture content of the fungi protein source, an optional step 130 of mixing the fungi protein source with a secondary protein source and/or other ingredients to thereby form a blend, and a step 140 of extruding the blend to thereby form a textured protein food product. Because steps 120 and 130 are optional to the overall method 100, these steps are shown in FIG. 1 using broken line boxes. Steps 120 and may be omitted from the method 100 completely or may optionally be included in method 100 in any order.

With respect to step 110 of providing a fungi protein source, any type of fungi can be used as the fungi protein source of the textured protein food product to be produced by the methods described herein. In some embodiments, whole fungal cells with intact fungal fibers are provided in step 110. In some embodiments, the fungi protein source provided in step 110 is fungi material grown from liquid or solid fermentation. In other embodiments, the fungi source is obtained from the mycelium of fruiting fungi, i.e., edible mushrooms. Non-limiting examples of fungi protein source that can be used in step 110 include fungi from the Aspergillus genus, fungi from the Fusarium genus, and fungi from the Neurospora genus. In one specific example, the fungi protein source is Koji.

With respect to optional step 120, the moisture content of the fungi protein source provided in step 110 may be adjusted. Any manner of increasing or decreasing, as necessary, the moisture content can be used. In some examples, injection of steam, direct addition of water and mixing, application or heat, application of vacuum, and/or centrifugation can be used to adjust the moisture content of the fungi protein source.

In addition to water content, various other parameters of the fungi protein source can be adjusted as part of optional step 120. In some embodiments, the other parameters of the fungi protein source to be adjusted are selected based at least in part on the extrusion process to be carried out and/or the desired characteristics of the end product. Exemplary, though non-limiting, parameters of the fungi protein source that can be adjusted as needed include total protein content, protein dispersibility (preferably between 20 and 70), nitrogen solubility index, oil content (preferably between 0.5 and 6.5%), fiber content (up to 6%), and particle size (preferably from 38 to 180 microns).

With respect to optional step 130, the fungi protein source can be mixed with other ingredients to be included in the final textured protein food product. Step 130 may include mixing the fungi protein source with one or more secondary protein sources and/or one or more non-protein materials. Exemplary, though non-limiting, examples of non-protein ingredients that may be mixed with the fungi protein source include flavors, fats, binders, and additives to promote protein binding and extrusion. Secondary protein sources can include any non-fungi protein sources as well as protein separated, isolated, extracted or otherwise derived from fungi (e.g., fungi protein isolate or fungi protein concentrate). Generally speaking, secondary protein sources exclude fungi protein sources that have intact fungal fibers such that the fungal protein cannot be accessed without breaking the fungal fibers. Examples of non-fungi secondary protein sources that may be mixed with the fungi protein source include flours, protein concentrates, and/or protein isolates from legumes (soy, chickpea, pea, lentils, fava beans, navy beans) or cereals (wheat gluten).

When both fungi and secondary protein sources are used, any ratio of fungi to secondary protein source can be used, though in some embodiments, the fungi-based protein is greater than 50 wt. % of the total protein content, or at least the predominant or majority source of protein content. In some embodiments, the fungi- based protein is greater than 70 wt. %, greater than 75 wt. %, greater than 80 wt. %, greater than 85 wt. %, greater than 90 wt. %, or greater than 95 wt. % of the total protein content.

Any manner of mixing the fungi protein source with other ingredients can be used in optional step 130. In some embodiments, the mixing is performed with relatively low shear or force to avoid damaging the ingredients and/or protein sources. In some embodiments, mixing is carried out until the ingredients are intimately and/or homogenously mixed to thereby form a blend of ingredients.

In some embodiments, preparation of the blend in optional step 130 includes mixing the fungi protein source with at least a protein powder (e.g., a non-fungi protein powder or protein powder including isolated fungal protein). In such embodiments, the fungi protein source may be wet or dry when mixed with the protein powder. In embodiments where the fungi protein source is wet, the mixing of the wet fungi protein source with the protein powder may be performed over a period of time to allow for a diffusion of moisture from the fungi protein source to the surrounding protein powder. Diffusion of the moisture from the fungi protein source to the protein powder may continue for an extended period of time if the mixture is held at cooler temperatures (e.g., refrigerated temperatures).

Not all ingredients to be mixed with the fungi protein source need be mixed with the fungi protein source at optional step 130. As discussed in greater detail below with respect to extrusion step 150, some or all of the ingredients to be mixed with the fungi protein source may be blended with the fungi protein source as part of the extrusion step 150. In such embodiments, the extrusion equipment may include, e.g., an inline mixer that will pump the ingredients into the extruder, at which point mixing with the fungi protein source occurs.

While not shown in FIG. 1, an additional optional step of adjusting the moisture content of the blend formed in optional step 130 can be carried out prior to extrusion. Adjusting the moisture content of the blend can be carried out during and/or after creation of blend. Adjusting the moisture content of the blend can include adding or removing moisture content. In some embodiments, the moisture content of the blend is adjusted as part of preparing the blend for extrusion (step 150 described in greater detail below). As with optional step 120 (adjusting the water content of the fungi protein source), any manner of increasing or decreasing, as necessary, the moisture content of the blend can be used. In some examples, injection of steam, direct addition of water and mixing, application or heat, application of vacuum, and/or centrifugation are used. In some embodiments, the moisture content of the blend is reduced prior to extrusion. In such embodiments, it is desirable to remove a portion of the moisture, but not so much as to create a thick paste.

At any point between providing the fungi protein source (step 110) and extruding the fungi protein source (optionally blended with other ingredients), an optional step of partially or fully denaturing some or all of the secondary protein can be performed. The optional step of partially or fully denaturing secondary protein may be carried out in order to better condition the secondary protein such that it is easier to denature during extrusion and/or is immediately available for elongation, alignment and network formation during extrusion. Any manner of carrying out partial or full protein denaturing can be used as part of this optional step, provided that only partial or full denaturing of secondary protein is carried out. Care should be taken to avoid processes and/or processing parameters that may lead to the breaking of fungal fibers. In some non-limiting examples, protein denaturing is performed by autolysis (cell disruption by enzymes endogenous to the fungi), heat treatment, or by treatment with exogenous enzymes, acids, or physical disruption.

In some embodiments, the optional denaturing step is aimed at preparing secondary protein for easier denaturation during extrusion. That is to say, the optional step may partially but not fully denature the secondary protein such that less harsh extrusion operating parameters are needed to complete denaturation of the secondary protein during extrusion than would be necessary if no partial denaturation was performed prior to extrusion. In this manner, secondary proteins that are more difficult to denature (e.g., require higher shear forces, temperatures and/or pressure to accomplish denaturation) may become available for use in the methods described herein since the pre-denaturing step will allow for the complete denaturation of the secondary proteins during extrusion at less harsh extrusion operating parameters.

In step 140, the blend of fungi protein source and other ingredients is subjected to extrusion to produce a fungi-based textured protein food product. While this disclosure generally refers to extrusion and use of an extruder, it should be appreciated that any extruder, former or other similar type of equipment that can be used to apply heat, shear and/or pressure to the blend in order to plasticize the material, modify the tertiary structure of the proteins and create a fibrous texture can be used. In some embodiments, the application of these forces are considered to “cook” the material.

Any type of extruder, former or similar equipment can be used to carry out the extrusion process. Exemplary, though non-limiting, extruders include single screw and twin- screw extruders. Operating parameters of the extruder and extrusion process that can be adjusted as needed include, but are not limited to, screw profile, extruder length/diameter ratio, rotation speed, rotation direction, screw configuration, zoning, and temperature and/or pressure profiles across various zones.

In some embodiments, the specific extrusion process and/or equipment used can generally be determined based on the moisture content of the material being extruded. In some embodiments, a low or intermediate moisture extrusion is carried out (specifically suitable for the production of, e.g., dry, textured vegetable protein- type products), while in other embodiments, high moisture extrusion cooking (HMEC) is used (specifically suitable for production of, e.g., high moisture meat analogs (HMMAs)). Generally speaking, when the moisture content of the material passed into the extruder is greater than 50%, the extrusion process is a high moisture extrusion cooking, while a moisture content in the range of 10 to 25% will follow a low/intermediate moisture extrusion process.

Generally speaking, extrusion step 140 includes loading the fungi protein source (which may be part of a blend) into a hopper or similar loading component of an extruder or former, optionally adding or removing water to adjust the water content of the material to be extruded, extruding the material, and then performing various optional post processing steps dependent on the specific type of extrusion process used and the product formed.

After the blend is loaded in the loading component of the extruder, moisture can be added or removed to achieve any desired moisture level. When adding water to increase the moisture content, moisture content can be increased by, e.g., direct addition of water to the blend loaded in the extruder or by steam injection.

In embodiments where the material fed into the extruder is “wet” (i.e., has relatively high moisture content), the amount of water added to the material during extrusion is reduced as compared to the amount of water added during extrusion when dry powder is the input material. Despite this addition of less water during extrusion, the moisture content of the extruded product is similar to the moisture content of extruded product formed from dry powder input.

As noted previously, the extruder may also be fitted with an inline mixer to add ingredients to the fungi protein source or blend such that these ingredients are added to the fungi protein source or blend as it enters or as it is passing through the extruder. Exemplary ingredients that can be added via such an inline mixer include flavors or secondary protein sources. In some embodiments, all ingredients to be added to the fungi protein source provided in step 110 are added via the inline mixer, while in other embodiments, some ingredients are mixed with the fungi protein source to form a blend (step 130) prior to the start of extrusion and the remaining ingredients are added via the inline mixer during extrusion step 140.

During extrusion, the blend of material (including the fungi protein source) is subjected to shear forces, increased temperature and increased pressure. As such, the extrusion leads to at least the ordering of the fungal fibers of the fungal protein source within the textured protein food product produced by the extrusion. Prior to extrusion, the fungal fibers are dispersed throughout the blend in an essentially random arrangement. The extrusion process leads to the fungal fibers being orderly re-arranged, such as an into an orderly pattern generally dictated by the mechanism used to subject the blend to shear forces. For example, when the extruder used is a twin-screw extruder, the orderly re-arrangement of the fungal fibers will follow a pattern imparted by the rotation of the twin screws and the shear forces imparted on the fungal fibers by the twin screws. This may take the form of, e.g., a helical or corkscrew arrangement of the fungal fibers.

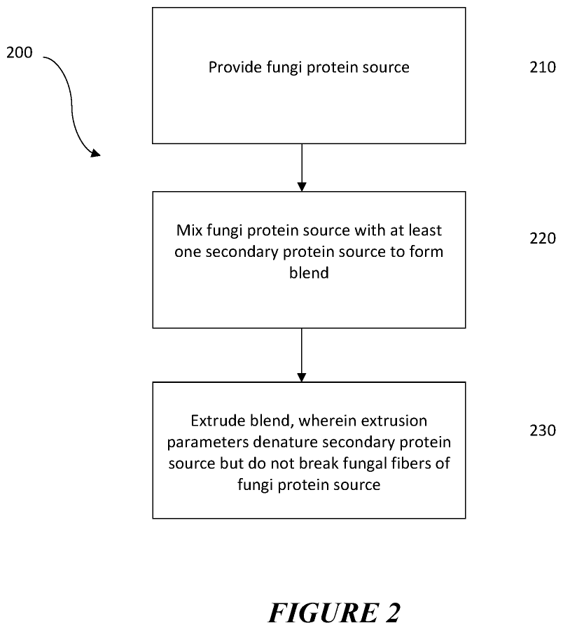

With reference to FIG. 2, one specific and preferred embodiment of the general method 100 shown in FIG. 1 is illustrated. Method 200 generally includes a step 210 of providing a fungi protein source, a step 220 of mixing the fungi protein source with at least one secondary protein source to form a blend, and a step of 230 of extruding the blend using extruder operating parameters that denature the protein in the secondary protein source but which do not destroy or break a substantial amount of the intact fungal fibers present in the fungi protein source. As used herein, the term “substantial” (and variations thereof) means greater than 60%. Thus, an aim of the extrusion step 230 is to select extrusion operating parameters that will denature the second protein but that will not break or destroy more than 60% of the fungal fibers in the fungi protein source. In some embodiments, less tolerance for breaking fungal fibers is permitted. For example, in some embodiments, it may be desirable that extrusion break less than 55%, less than 50%, less than 45%, less than 40%, less than 35%, less than 30%, less than 25%, less than 20%, less than 15%, less than 10%, or less than 5% of the fungal fibers. In some embodiments, it is preferred that the extrusion break none or less than 1% of the fungal fibers.

With reference to step 210, a fungi protein source is provided. This step may be similar or identical to step 110 discussed in greater detail previously.

With reference to step 220, the fungi protein source is mixed with at least one secondary protein source to form a blend. Other ingredients as described in more detail previously may also be mixed with the fungi protein source, but at least one secondary protein source must be mixed with the fungi protein source as part of step 220. The specific manner of mixing the fungi protein source and at least one secondary protein source is not limited, and the timing of mixing the secondary protein source with the fungi protein source is also not limited. In some embodiments, the secondary protein source is mixed with the fungi protein source to form a blend prior to the start of extrusion in step 230, while in other embodiments the secondary protein source is mixed with the fungi protein source as part of the extrusion step 230 (such as introducing the secondary protein source into the extruder via an inline mixer to mix together the secondary protein source and the fungi protein source as the fungi protein source is fed into the extruder).

In some embodiments, the secondary protein source mixed with the fungi protein source is specifically selected as a protein source whose proteins will denature at extrusion operating parameters below the extrusion operating parameters that would result in any, or at least not substantial, destruction or breaking of fungal fibers in the fungi protein source. In other words, the secondary protein source is a protein source whose protein is relatively easily denatured when exposed to minimal shear, temperature and/or pressure ranges. Selection of a secondary protein source that is easily denatured helps to ensure that the extrusion can be carried out at operating parameters that will partially or completely denature the protein of the secondary protein source while completely or substantially avoiding the breaking or destruction of fungal fibers of the fungi protein source. Exemplary secondary protein sources that meet this criteria include globular proteins, such as globulins, glutelins, and prolamins.

The ratio of secondary protein source to fungi protein source used when creating a blend in step 220 is generally not limited. In some embodiments, the fungi protein source is the predominant or majority component of the blend. In some embodiments, the blend comprises at least 50 wt % fungi protein source, though lower fungi protein source amounts can be used (e.g., 10 wt. %, 20 wt. %, 30 wt. %, or 40 wt. %).

Following the mixing of the at least one secondary (and easily denatured) protein source and the fungi protein source in step 220, the blend is subjected to extrusion in step 230. The extrusion step can be carried out in a similar or identical manner to the previous description of extrusion step 140 and using similar or identical equipment as described previously with respect to extrusion step 140. However, the extrusion step 230 may differ from extrusion step 140 in that the operating parameters (e.g., shear force, temperature and pressure) are adjusted such that the extrusion process denatures the protein of the secondary protein source but does not completely or substantially break or destroy the fungal fibers of the fungi protein source. Generally speaking, this requires at least selecting any combination of operating parameters that are below what is required to initiate the breaking of fungal fibers in the fungi protein source. In some embodiments, the secondary protein source is selected so that protein denaturing occurs substantially below the extrusion operating parameters required to initiate destroying or breaking the fungal fibers of the fungi protein source. This may allow for the use of extrusion operating parameters that are well below what is required to initiate breaking or destroying of fungal fibers of the fungi protein source but which will still easily denature the protein of the secondary protein source. This helps to further ensure that little to no fungal fibers of the fungi protein source are broken.

The aim of step 230 is to perform extrusion in such a manner that secondary protein is denatured while fungi fibers of the fungi protein source remains intact. When this is accomplished, the denatured protein of the secondary protein source is elongated during the extrusion process. The elongated denatured protein is also aligned with the intact fungal fibers as a result of the continued extrusion. Finally, the elongated strands of denatured proteins begin to interact with each other to form networks or matrices of denatured protein strands about the fungal fibers. The result of this configuration is the production of a textured protein food product that has a texture closely mimicking that of natural meat. Furthermore, the network of denatured protein strands formed about and aligned with the intact fungal fibers creates a sufficient heterogeneity within the textured protein product that results in a further improvement in the mimicry of the product to natural meat. For example, this heterogeneity results in the food product breaking apart unevenly when torn, which mimics the result of tearing natural meat. Without this heterogeneity, textured protein product may break apart in an unnatural even way.

Following the general extrusion process of step 140 of FIG. 1 or step 230 of FIG. 2, various additional optional steps may be performed based on, for example, the specific extrusion process that was carried out (e.g., intermediate moisture extrusion vs. high moisture extrusion cooking).

In some embodiments, a post-processing step includes a cooling step. When HMEC is used to prepare HMMA, a post-extrusion cooling can be carried out by passing the extrudate through a cooling die to elongate the fibers in the extruded material.

In other optional post processing step, cutting and/or forming steps can be carried out. For example, as the material exits the extruder, various cutting and/or forming steps may be carried out in order to provide any variety of shapes of the produced product.

In still another optional prost processing step, a drying step can be carried out. For example, following cutting/forming, a drying step may be carried out, specifically in the case of intermediate moisture extrusion for the production of textured vegetable protein-type products.

Following optional drying of extrudate via any suitable means, additional cutting steps may be carried out, such as shredding, shaping, etc. Following these cutting steps, additional flavoring and/or coating can be performed. Finally, steps to prepare the finished product for storage can be carried out. In the case of textured vegetable protein-type products, this may include drying the product to reduce the moisture content, while for HMMA, the product may be refrigerated or frozen.

Thus produced, the final textured protein food product including fungi may be used for a variety of purposes, primary of which is for use as human foods (meat and seafood alternatives as well as snacks and other textured foods that have protein in them). Alternative uses include, e.g., animal and pet feed, or uses outside food such as composite materials. The final product could also be used as feed for further fermentation processes.

The fungi-based textured protein food product described herein generally comprises a fungi protein source and optionally other ingredients, such as of flavors, fats, binders, and other secondary protein sources. In some embodiments, the fungi protein source is the predominant or majority component of the textured protein food product. In some embodiments, the fungi protein source is more than 50 wt. % of the textured protein food product.

In some embodiments, the textured protein food product includes ordered and intact fungal fibers. The fungal fibers may be ordered by virtue of the extrusion process used to form the textured protein food product. As described in greater detail above, the ordered fungal proteins may generally have an order imparted by virtue of the shear force applied to the blend during extrusion. In some embodiments, this order to the arrangement of the fungal fibers may be considered an aligned arrangement, though the fungal fibers need not or may not be uniaxially aligned. Instead, the alignment may be based on the shear force applied during extrusion. In the case of an extrusion process wherein twin screws are used, the alignment provided to the fungal fibers may be in a helical or corkscrew direction or pattern.

In some embodiments, the structure of the textured protein food product further includes numerous networks of denatured strands of secondaery protein. As discussed in greater detail above, these networks are created during extrusion. More specifically, the proteins of the secondary protein source are denatured by virtue of the operating parameters of the extrusion process. Once denatured, the extrusion causes the broken chains of amino acids to elongate. During elongation and as extrusion proceeds, the broken chains of amino acids begin to connect with each other, thereby forming networks of denatured secondary protein. These networks are dispersed about the fungal fragments and, because of the shear forces applied during extrusion, generally align (i.e., arrange generally in parallel) with the fungal fibers.

Significantly, the extrusion processing is carried out in such a way as to prevent the breaking or destruction of fungal fibers in the fungi protein source. Generally speaking, for fungal proteins to be denatured, the fungal fibers must first be broken to thereby expose the proteins. Accordingly, one manner in which the extrusion is carried out to avoid denaturing fungal proteins is to select operating parameters for the extrusion (e.g., shear, temperature and pressure) that do not result in the breaking of fungal fibers. In so doing, the final textured protein food product generally includes a plurality of unbroken (i.e., intact) fungal fibers arranged in an orderly pattern and aligned with networks or matrices of denatured secondary protein formed about and around the intact fungal fibers.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/we claim:

1. A method of forming a fungi-based textured protein food product, comprising:
providing a fungi-based protein source, the fungi-based protein source comprising a plurality of fungal fibers;
mixing the fungi-based protein source with at least one secondary protein source to form a blend; and
extruding the blend to form a fungi-based textured protein food product;
wherein extruding the blend is carried out in a manner such that the secondary protein is denatured and greater than 40% of the fungal fibers remain intact.

2. The method of claim 1, wherein extruding comprises applying shear force, elevated pressure and elevated temperature to the blend, and wherein the shear force, elevated pressure and elevated temperature are set such that the secondary protein is denatured and greater than 40% of the fungal fibers remain intact.

3. The method of claim 1, wherein extruding the blend is further carried out in manner such that after the secondary based protein is denatured, the denatured protein is elongated and forms networks of denatured protein around and about the plurality of fungal fibers.

4. The method of claim 3, wherein extruding the blend is further carried out in a manner that aligns the networks of denatured protein with the plurality of fungal fibers.

5. The method of claim 3, wherein extruding the blend is carried out such that greater than 95% of the fungal fibers remain intact.

6. The method of claim 2, wherein the secondary protein source comprises a non-fungi protein that denatures at a lower shear force, lower pressure and/or lower temperature than a shear force, pressure and/or temperature at which the fungal fibers of the fungi-based protein source break.

7. The method of claim 2, wherein the shear force, pressure and/or temperature used for extruding the blend does not break any of the fungal fibers of the fungi-based protein source.

8. The method of claim 1, further comprising:
prior to extruding the blend to form the fungi-based textured protein food product, partially or fully denaturing some or all of the secondary protein source.

9. The method of claim 8, wherein partially or fully denaturing some or all of the secondary protein source is carried out after mixing the fungi-based protein source with the at least one secondary protein source to form the blend, and partially or fully denaturing some or all of secondary protein source is carried out in a manner that does not break more than 60% of the fungal fibers of the fungi protein source.

10. A fungi-based textured protein food product, comprising:
a fungi-based protein source comprising a plurality of intact fungal fibers; and
a plurality of networks of denatured protein arranged around and about the plurality of intact fungal fibers.

11. The fungi-based textured protein food product of claim 10, wherein the plurality of fungal fibers are arranged in a pattern.

12. The fungi-based textured protein food product of claim 10, wherein the plurality of networks of denatured protein are aligned with the plurality of fungal fibers.

13. The fungi-based textured protein food product of claim 10, further comprising fat, flavoring, binders, or any combination thereof.

14. The fungi-based textured protein food product of claim 10, wherein the fungi-based protein source comprises at least 50 wt. % of the fungi-based textured protein food product.

15. The fungi-based textured protein food product of claim 10, wherein the plurality of networks of denatured protein derives from fungi protein concentrate or fungi protein isolate.
